(19) United States
(12) Patent Application Publication
(10) Pub. No.: US 2017/0142760 A1
(43) Pub. Date: May 18, 2017

(54) METHOD AND APPARATUS FOR ESTABLISHING CONNECTION TO DATA SERVICE

(71) Applicant: Xiaomi Inc., Beijing (CN)

(72) Inventors: Jiangtao HUANG, Beijing (CN); Yanjun KANG, Beijing (CN); Lin DAI, Beijing (CN)

(73) Assignee: Xiaomi Inc

(21) Appl. No.: 15/353,410

(22) Filed: Nov. 16, 2016

(30) Foreign Application Priority Data
Nov. 17, 2015 (CN) 201510792630.1

(51) Int. Cl. H04W 76/02; H04L 29/12

(52) U.S. Cl. CPC H04W 76/021; H04L 61/2007; H04W 76/027

(57) ABSTRACT

A method is provided for establishing a connection to a data service. The method is implemented by a mobile terminal. The method includes, when initiating a first request on a Long Term Evolution (LTE) network for connecting to the data service with a first Access Point Name (APN) preset in the mobile terminal fails, acquiring a second APN. The second APN is assigned to the mobile terminal by the LTE network when the mobile terminal is attached to the LTE network. The method also includes initiating a second request on the LTE network for connecting to the data service with the second APN, to establish the connection to the data service.

### CROSS-REFERENCE TO RELATED APPLICATION

The present application is based upon and claims priority to Chinese Patent Application No. 201510792630.1, filed on Nov. 17, 2015, the entire contents of which are incorporated herein by reference.

### TECHNICAL FIELD

The present disclosure generally relates to the field of mobile communication technology, and more particularly, to a method and an apparatus for establishing a connection to a data service.

### BACKGROUND

At present, when a mobile terminal requires a data service, the mobile terminal initiates a request on a network for establishing a connection to the data service through a preset (i.e., previously set) Access Point Name (APN), in order to establish the connection to the data service for the mobile terminal.

The APN is a parameter that is required to be set when the mobile terminal is connected to a network. The APN determines an access mode through which the mobile terminal accesses a Long Term Evolution (LTE) network. Different network operators may use different network standards. For example, for a China Mobile network, an operating system (e.g., an Android® system) of the mobile terminal may set CMNET (a preset APN for the China Mobile network) for initiating the request for establishing a connection to a data service provided by the China Mobile network. For a China Telecom network, the Android system may initiate the request for establishing a connection to a data service provided by the China Telecom network through CTNET (a preset APN for the China Telecom network).

### SUMMARY

According to a first aspect of the present disclosure, there is provided a method for establishing a connection to a data service. The method is implemented by a mobile terminal. The method includes, when initiating a first request on a Long Term Evolution (LTE) network for connecting to the data service with a first Access Point Name (APN) preset in the mobile terminal fails, acquiring a second APN. The second APN is assigned to the mobile terminal by the LTE network when the mobile terminal is attached to the LTE network. The method also includes initiating a second request on the LTE network for connecting to the data service with the second APN, to establish the connection to the data service.

According to a second aspect of the present disclosure, there is provided an apparatus for establishing a connection to a data service. The apparatus includes a processor, and a memory for storing instructions executable by the processor. The processor is configured to execute the instructions to perform, when initiating a first request on a Long Term Evolution (LTE) network for connecting to a data service with a first Access Point Name (APN) preset in the mobile terminal fails, acquiring a second APN. The second APN is assigned to the mobile terminal by the LTE network when the mobile terminal is attached to the LTE network. The processor is also configured to execute the instructions to perform: initiating a second request on the LTE network for connecting to the data service with the second APN, to establish the connection to the data service.

According to a third aspect of the present disclosure, there is provided a non-transitory computer-readable storage medium. The non-transitory computer-readable medium stores instructions that, when executed by a processor of a mobile terminal for establishing a connection to a data service, cause the processor to perform a method. The method includes, when initiating a first request on a Long Term Evolution (LTE) network for connecting to the data service with a first Access Point Name (APN) preset in the mobile terminal fails, acquiring a second APN. The second APN is assigned to the mobile terminal by the LTE network when the mobile terminal is attached to the LTE network. The method also includes initiating a second request on the LTE network for connecting to the data service with the second APN, to establish the connection to the data service.

It is to be understood that both the foregoing general description and the following detailed description are exemplary only and are not restrictive of the present disclosure.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flowchart illustrating a method for establishing a connection to a data service, according to an exemplary embodiment;

FIG. 2 is a flowchart illustrating step S11 included in the method shown in FIG. 1 for establishing a connection to a data service, according to an exemplary embodiment;

FIG. 3 is a flowchart illustrating step S11 included in the method shown in FIG. 1 for establishing a connection to a data service, according to an exemplary embodiment;

FIG. 4 is a flowchart illustrating step S12 of the method shown in FIG. 1 for requesting to connect to a data service provided by a mobile communication network, according to an exemplary embodiment;

FIG. 5 is a block diagram illustrating an apparatus for establishing a connection to a data service, according to an exemplary embodiment;

FIG. 6 is a block diagram illustrating a first data-service connection module, according to an exemplary embodiment;

FIG. 7 is a block diagram illustrating an acquiring module in an apparatus for establishing a connection to a data service, according to an exemplary embodiment;

FIG. 8 is a block diagram illustrating a second data-service connection module, according to an exemplary embodiment; and

FIG. 9 is a block diagram illustrating an apparatus for establishing a connection to a data service, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

In the related art, when a mobile terminal requires a data service, an operating system (e.g., an Android™ system) of the mobile terminal may initiate a request for establishing a connection to the data service through a preset APN after the mobile terminal is properly registered in an LTE network. For example, if the mobile terminal is registered in a China Mobile network, the Android system of the mobile terminal may initiate a request for a data service with CMNET (a preset APN for the China Mobile network). If the mobile terminal is registered in a China Telecom network, the Android system may initiate a request for a data service with CTNET (a preset APN for the China Telecom network).

However, if an error occurred in selecting the APN by the Android system (for example, the preset APN is incorrect, the Android system selected an incorrect APN, or the preset APN does not contain APNs for all the networks and some APNs are omitted), or the APN assigned to the LTE network (also referred to as the attach APN) is inconsistent with the preset APN of the mobile terminal, the APN with which the Android system of the mobile terminal initiates the request is inconsistent with the APN actually assigned by the communication network during registration. As a result, the connection to the data service cannot be established. For example, when the mobile terminal is installed with a Subscriber Identity Module (SIM) card of a network operator, but the Android system of the mobile terminal does not set in advance the APN of the network operator, the mobile terminal may not be able to establish a connection to a data service after the mobile terminal is registered in the LTE network of the network operator. For example, for the China Telecom network, if the preset APN is CTNET, but the APN actually assigned by the network is CTLTE, the mobile terminal will not be able to establish a connection to the data service.

In order to solve the above problems of not being able to establish a connection to a data service, the present disclosure provides a method for establishing a connection to a data service.

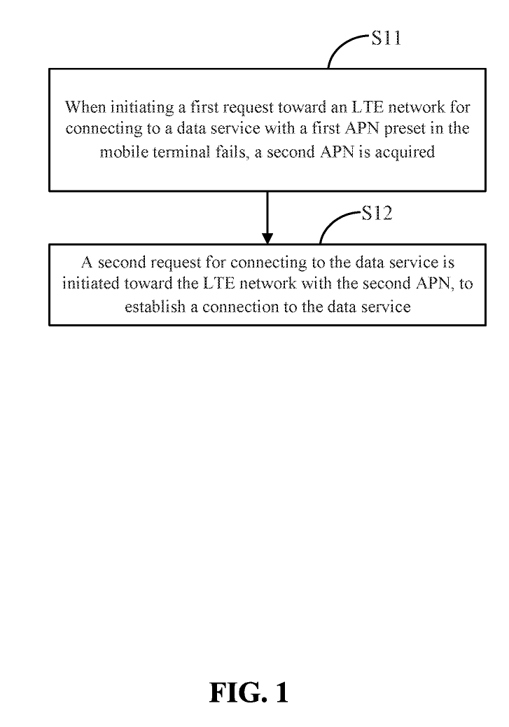

FIG. 1 is a flowchart illustrating a method for establishing a connection to a data service according to an exemplary embodiment. As shown in FIG. 1, the method for establishing a connection to a data service is applied in or implemented by a mobile terminal. The method includes steps S11 and S12.

In step S11, when initiating a first request on an LTE network for connecting to a data service with a first Access Point Name (APN) preset in the mobile terminal fails, a second Access Point Name (APN) is acquired. The second APN is an access point name assigned to the mobile terminal by the LTE network when the mobile terminal is attached to (e.g., registered in) the LTE network (the LTE network to which the mobile terminal is attached may be referred to as an attached LTE network).

In step S12, a second request for connecting to the data service is initiated on the LTE network with the second APN to establish the connection to the data service.

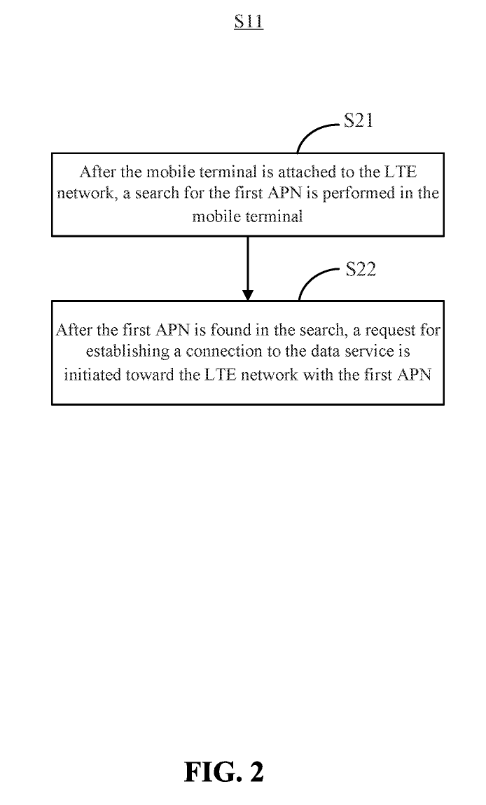

In one embodiment, as shown in FIG. 2, in step S11, initiating the first request on the LTE network for connecting to a data service with the first APN preset in the mobile terminal includes steps S21 and S22.

In step S21, after the mobile terminal is attached to the LTE network, a search for the first APN (e.g., a preset APN) is performed in the mobile terminal.

The LTE network may include various networks that provide data services to the user, such as, LTE networks of different standards (e.g., TDD-LTE, FDD-LTE, and the like).

In step S22, after the first APN is found in the search, the first request for connecting to the data service is initiated on the LTE network with the first APN.

In some embodiments, step S22 may further include determining that initiating the first request on the LTE network with the first APN for connecting to the data service has failed. For example, when a message fed back from the LTE network is received indicating failure to establish a connection to the data service provided by the LTE network, it may be determined that initiating the first request on the LTE network for connecting to the data service with the first APN preset in the mobile terminal has failed.

In the disclosed embodiments, for discussion purposes, the preset APN selected by the mobile terminal is referred to as the first APN, and the APN assigned to the mobile terminal when the mobile terminal is attached to the LTE network is referred to as the second APN.

In the disclosed embodiments, when initiating a request on an LTE network for connecting to a data service with the first APN preset in the mobile terminal fails, the second APN is acquired. The second APN is assigned to the mobile terminal when the mobile terminal is attached to the LTE network. A request for connecting to the data service is initiated on the attached LTE network with the second APN, in order to establish a connection to the data service for the mobile terminal. With the disclosed method for establishing a connection to a data service, when the APN preset in the mobile terminal is incorrect, or when the attach APN (i.e., the second APN) assigned by the LTE network is inconsistent with the preset APN, or when the mobile terminal does not set in advance a corresponding APN for the currently attached network, a correct APN can be found timely and reliably for the mobile terminal such that a connection to the data service can be established. Therefore, the problems existing in the related art can be solved.

The steps will be respectively described in detail below.

In step S21, after the mobile terminal is registered in the LTE network, the preset APN (i.e., first APN) is searched for in the mobile terminal. In some embodiments, the mobile terminal sets in advance different APNs corresponding to various networks run by different operators and/or using different standards, such as CMNET or CTNET. According to a type of the registered LTE network, the mobile terminal searches for a first APN from the stored preset APNs that corresponds to the type of the network.

For example, if the mobile terminal determines that the currently registered network is an LTE network operated by China Mobile, the mobile terminal selects a preset APN CMNET as the first APN. If the mobile terminal determines that the current network is an LTE network operated by China Telecom network, the mobile terminal selects a preset APN CTNET as the first APN.

If the preset APNs do not contain an APN corresponding to the currently registered network, the mobile terminal selects a default preset APN as the first APN.

In one embodiment, after a first request for connecting to a data service is initiated on the LTE network with the first APN to establish a connection to the data service, the result of initiating the first request may be either of: the connection to the data service is successfully established with the first APN, or the connection to the data service fails to be established with the first APN.

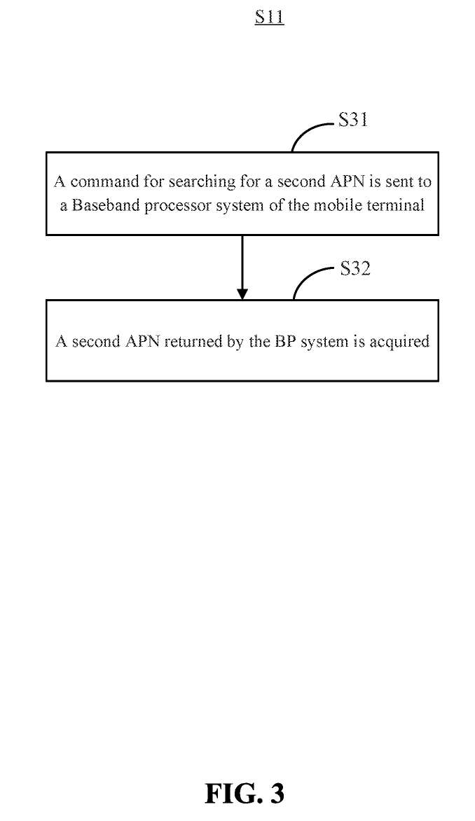

When initiating a first request for connecting to the data service with the first APN fails, at step S11, a second APN is acquired. The second APN is an access point name assigned to the mobile terminal by an LTE network when the mobile terminal is registered in the LTE network. In some embodiments, as shown in FIG. 3, step S11 is implemented as follows.

In step S31, a command for searching for a second APN is sent to a Baseband processor (BP) system of the mobile terminal.

The second APN is the attach APN assigned to the mobile terminal by the attached LTE network (i.e., the LTE network to which the mobile terminal is attached).

In step S32, a second APN returned by the BP system is acquired.

Steps S21 and S22 may be performed by the operating system (e.g., an Android system) of the mobile terminal.

Software installed on the mobile terminal may be divided into an Application Processor (AP) (e.g., Android) system and a BP system.

The BP system handles communication with a base station to implement a communication function (such as a voice call) of the mobile terminal. During the process of registering in an LTE network, the BP system initiates an attaching process (i.e., registering process) with the LTE network. During the attaching process, the BP system acquires a second APN (i.e., the attach APN) assigned by the attached LTE network and an IP address assigned for the mobile terminal by the attached LTE network.

The attaching process with respect to the LTE network is initiated by the mobile terminal. The following is an example of the attaching process of the mobile terminal.

1) The user and the LTE network perform authentication with respect to each other, and the mobile terminal (UE, User Equipment) establishes a Mobility Management (MM) context with a Mobility Management Entity (MME);

2) The MME establishes a default carrier for the mobile terminal;

3) The UE acquires an IP address assigned by the network;

4) The UE registers the location of the user; and

5) The UE acquires an assigned temporal identification.

The above process is only an example of the attaching process, and the attaching (i.e., registering) process of the mobile terminal is not specifically limited in the present disclosure.

For the LTE network, the attach APN is generally a Gateway GPRS Support Node (GGSN) or an identification for a Packet Data Network Gateway (PGW) connected to an external network. During the attaching process, the LTE network may assign an attach APN for the mobile terminal to complete the attaching process. Therefore, the BP system of the mobile terminal may know about the attach APN, i.e., the second APN.

Accordingly, in some embodiments, the second APN may be acquired by sending to the BP system of the mobile terminal a command for searching for the attach APN assigned by the LTE network. Moreover, since the second APN is the attach APN assigned by the LTE network to which the mobile terminal is actually attached, the APN is often, if not always, correct. Therefore, the second APN ensures that the mobile terminal can properly establish the connection to the data service.

In one embodiment, sending the command for searching for the second APN (i.e., the attach APN) assigned by the LTE network to the BP system of the mobile terminal is implemented as follows.

The command for searching for the attach APN assigned by the LTE network is sent to the BP system of the mobile terminal through a Radio Interface Layer (RIL) of the mobile terminal.

The RIL is an abstract layer between a telephony service and a radio hardware layer of the Android system. The command for searching for the attach APN may be sent to the BP system through a command defined by the RIL. After the BP system feeds a result back to the RIL, the RIL feeds the result back to the Android system.

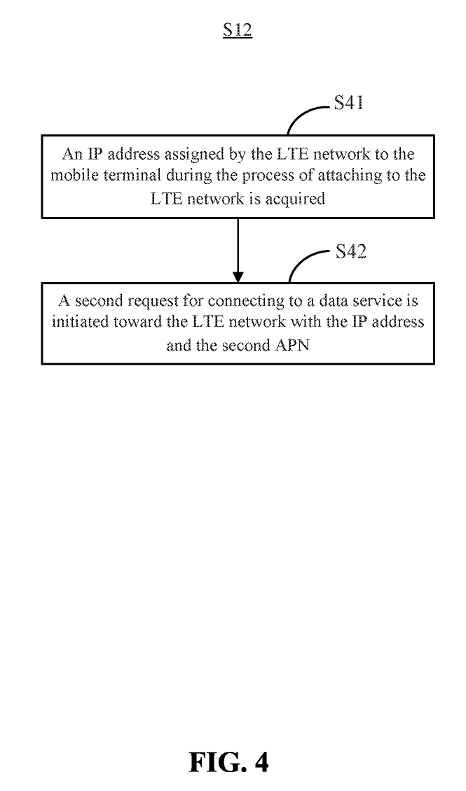

In one embodiment, as shown in FIG. 4, initiating a request on the LTE network for connecting to a data service with the second APN (step S12) includes the following steps.

In step S41, an IP address assigned by the LTE network to the mobile terminal during the process of attaching to the LTE network is acquired.

In step S42, a second request for connecting to a data service is initiated on the LTE network with the IP address and the second APN.

Based on the above-described process of registering the mobile terminal in the LTE network (i.e., attaching to the LTE network), the IP address assigned by the LTE network to the mobile terminal during the process of registering in the LTE network is acquired. The connection to the data service of the LTE network is then established with the acquired IP address and the second APN.

For example, if the mobile terminal uses a SIM card of China Mobile, after the attaching to a TD-LTE network of the operator (i.e., China Mobile), an upper operating system initiates a first request on the TD-LTE network for connecting to a data service with an APN CTNET preset in the mobile terminal and the IP address of the mobile terminal. The TD-LTE network feeds back a message indicating failure to establish the connection to the data service. Then, the mobile terminal sends to its BP system a command for searching for an attach APN. After the BP system returns an APN CMNET, the mobile terminal initiates a second request on the TD-LTE network for connecting to the data service with the IP address of the mobile terminal and the APN CMMET, to properly establish the connection to the data service.

The following are embodiments of the disclosed apparatus that may be configured to perform the disclosed methods.

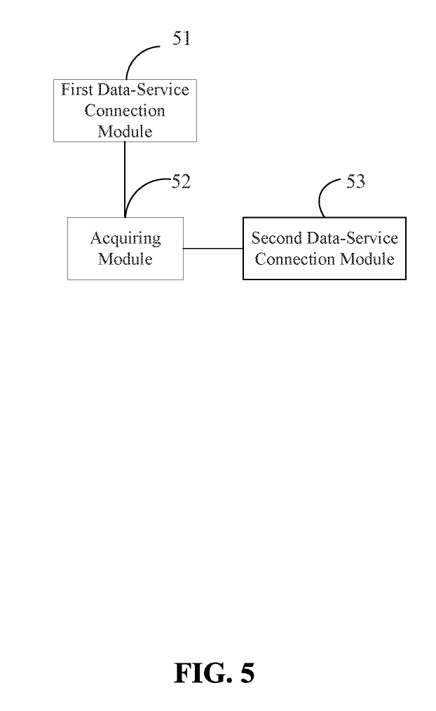

FIG. 5 is a block diagram illustrating an apparatus for establishing a connection to a data service according to an exemplary embodiment. The apparatus may be implemented as software, hardware, or combination thereof, to form one or more parts of an electronic device. The apparatus shown in FIG. 5 for establishing a connection to a data service may be applied in or implemented by a mobile terminal. The apparatus includes:

a first data-service connection module 51 configured to initiate a request on a Long Term Evolution (LTE) network for connecting to a data service with a first Access Point Name (APN) preset in the mobile terminal;

an acquiring module 52 configured to acquire a second APN, when initiating the first request on the LTE network for connecting to a data service with the first APN preset in the mobile terminal fails, the second APN being an access point name assigned to the mobile terminal by the LTE network when the mobile terminal is attached to the LTE network; and

a second data-service connection module 53 configured to initiate a second request on the LTE network for connecting to a data service with the second APN acquired by the acquiring module 52, to establish the connection to the data service.

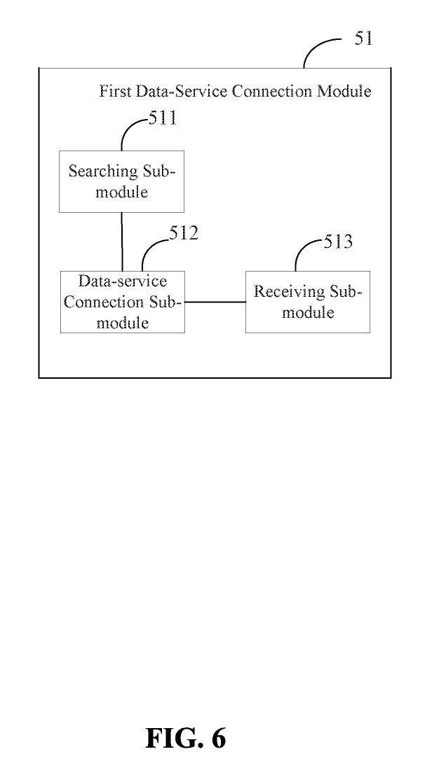

In one embodiment, as shown in FIG. 6, the first data-service connection module 51 includes a searching sub-module 511, a data-service connection sub-module 512, and a receiving sub-module 513.

The searching sub-module 511 is configured to search for the first APN preset in the mobile terminal after the mobile terminal is attached to the LTE network.

The data-service connection sub-module 512 is configured to initiate the first request on the LTE network for connecting to a data service with the first APN that is found by the searching sub-module 511.

The receiving sub-module 513 is configured to receive a message fed back by the LTE network indicating failure to establish a connection to the data service.

The acquiring module 52 is further configured to acquire the second APN when the message indicating failure to establish the connection to the data service is received.

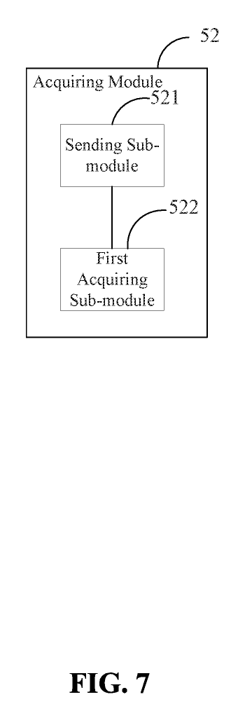

In one embodiment, as shown in FIG. 7, the acquiring module 52 includes a sending sub-module 521 configured to send a command for searching for a second APN to a Baseband processor (BP) system of the mobile terminal; and a first acquiring sub-module 522 configured to acquire a second APN returned by the BP system.

In one embodiment, the sending sub-module 521 is configured to send the command for searching for the second APN in the LTE network to the BP system of the mobile terminal through a Radio Interface Layer of the mobile terminal.

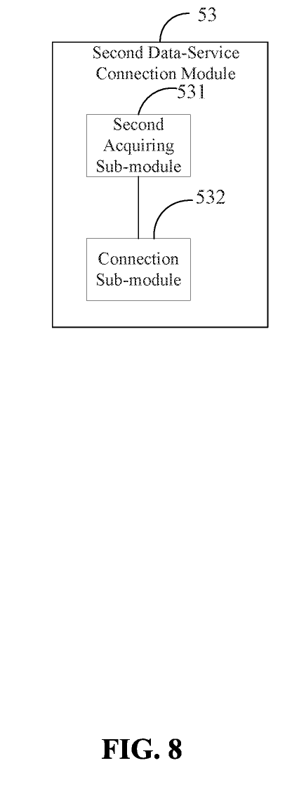

In one embodiment, as shown in FIG. 8, the second data-service connection module 53 includes a second acquiring sub-module 531 configured to acquire an IP address assigned by the LTE network to the mobile terminal during the process of attaching to the LTE network; and a connection sub-module 532 configured to initiate the second request on the LTE network for connecting to a data service with the IP address and the second APN.

In one embodiment, the searching sub-module 511 is configured to, according to a type of the attached LTE network, search for a first APN that corresponds to the type of the network from preset APNs stored in the mobile terminal.

According to an embodiment, there is provided an apparatus for establishing a connection to a data service, including: a processor and a memory for storing instructions executable by the processor. The processor is configured to perform the following: when initiating a first request on a Long Term Evolution (LTE) network for connecting to a data service with a first Access Point Name (APN) preset in the mobile terminal fails, acquiring a second APN, the second APN being an access point name assigned to the mobile terminal by the LTE network when the mobile terminal is attached to the LTE network. The processor is also configured to perform the following: initiating a second request on the LTE network for connecting to the data service with the second APN, to establish the connection to the data service.

In one embodiment, initiating the first request on an LTE network for connecting to a data service with the first APN preset in the mobile terminal includes: after the mobile terminal is attached to the LTE network, searching for the first APN preset in the mobile terminal; and initiating the first request on the LTE network for connecting to the data service with the first APN that is found in the mobile terminal.

In one embodiment, acquiring a second APN includes: sending a command for searching for the second APN to a Baseband processor system of the mobile terminal; and acquiring the second APN returned by the BP system.

In one embodiment, sending the command for searching for the second APN to the Baseband processor BP system of the mobile terminal includes: sending the command for searching for the second APN to the BP system of the mobile terminal through a Radio Interface Layer of the mobile terminal.

In one embodiment, initiating a second request for connecting the data service to the LTE network with the second APN includes: acquiring an IP address assigned by the LTE network to the mobile terminal during a process of attaching to the LTE network; and initiating the second request on the LTE network for connecting to the data service with the IP address and the second APN.

In one embodiment, searching for the first APN preset in the mobile terminal includes: according to a type of the attached LTE network, searching for the first APN that corresponds to the type of the network from preset APNs stored in the mobile terminal.

In the disclosed apparatus for establishing a connection to a data service, the first data-service connection module 51 initiates a first request on the LTE network for connecting to the data service with the first APN preset in the mobile terminal. If initiating the first request for connecting to the data service fails, a second APN is acquired by the acquiring module 52. The second APN is an APN assigned to the mobile terminal by the LTE network when the mobile terminal is attached to the LTE network. The second data-service connection module 53 initiates a second request on the registered LTE network for connecting to the data service with the second APN, to establish the connection to the data service for the mobile terminal. With the disclosed apparatus for establishing a connection to a data service, when the APN preset in the mobile terminal is incorrect, or when the attach APN (i.e., the second APN) assigned by the LTE network is inconsistent with the preset APN, or when the mobile terminal does not set in advance a corresponding APN for the currently attached network of an operator, a correct APN can be found timely and reliably for the mobile terminal such that the connection to the data service can be established. Therefore, the problems existing in the related art can be solved.

With respect to the disclosed apparatus, the specific manners for performing operations by individual modules included in the apparatus have been described in detail in the descriptions of the relevant methods.

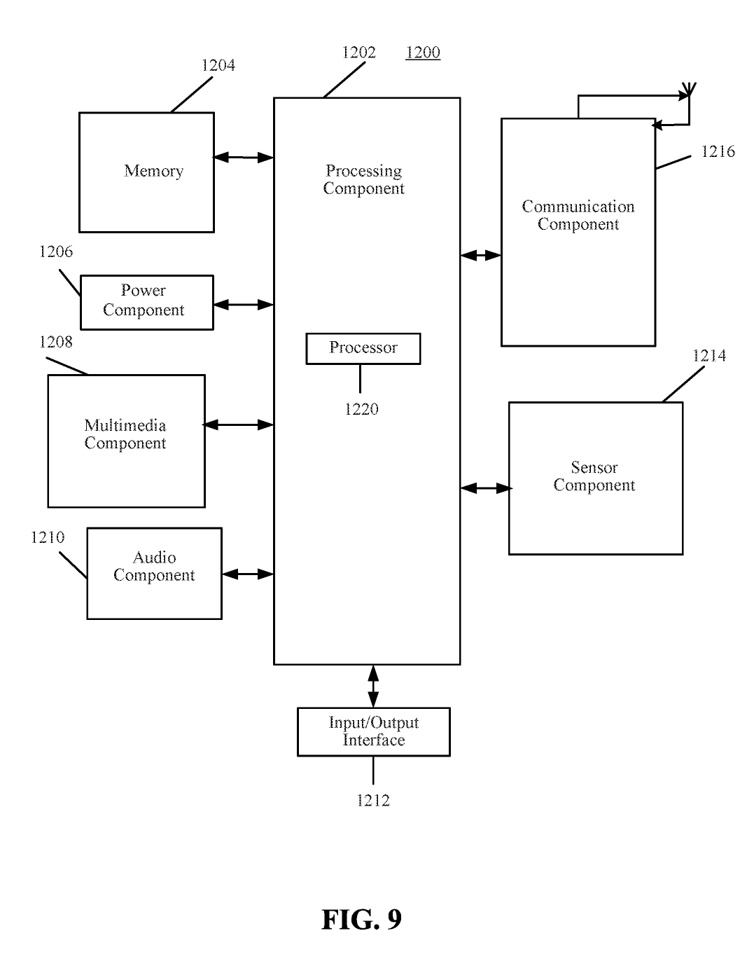

FIG. 9 is a block diagram illustrating an apparatus 1200 for establishing a connection to a data service according to an exemplary embodiment. Apparatus 1200 may be applied (e.g., implemented) in a terminal device (e.g., a mobile terminal). For example, the apparatus 1200 may be a mobile phone, a computer, a digital broadcast terminal, a messaging device, a gaming console, a tablet, a medical device, exercise equipment, a personal digital assistant, and the like.

The apparatus 1200 includes one or more of the following components: a processing component 1202, a memory 1204, a power component 1206, a multimedia component 1208, an audio component 1210, an input/output (I/O) interface 1212, a sensor component 1214, and a communication component 1216.

The processing component 1202 is configured to control overall operations of the apparatus 1200, such as the operations associated with display, telephone calls, and data communications, camera operations, and recording operations. The processing component 1202 includes one or more processors 1220 configured to execute instructions to perform all or part of the described methods. In some embodiments, the processing component 1202 includes one or more modules configured to facilitate the interaction between the processing component 1202 and other components. For example, in some embodiments, the processing component 1202 includes a multimedia module configured to facilitate the interaction between the multimedia component 1208 and the processing component 1202.

The memory 1204 is configured to store various types of data to support the operation of the apparatus 1200. Examples of such data include instructions for any applications or methods operated on the apparatus 1200, contact data, phonebook data, messages, pictures, video, etc. The memory 1204 can be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, or a magnetic or optical disk.

The power component 1206 is configured to provide power to various components of the apparatus 1200. In some embodiments, the power component 1206 includes a power management system, one or more power sources, and any other components associated with the generation, management, and distribution of power in the apparatus 1200.

The multimedia component 1208 includes a screen providing an output interface between the apparatus 1200 and the user. In some embodiments, the screen includes a liquid crystal display and a touch panel. If the screen includes the touch panel, the screen can be implemented as a touch screen to receive input signals from the user. The touch panel includes one or more touch sensors to sense touches, swipes, and gestures on the touch panel. The touch sensors not only sense a boundary of a touch or swipe action, but also sense a period of time and a pressure associated with the touch or swipe action. In some embodiments, the multimedia component 1208 includes a front camera and/or a rear camera. The front camera and the rear camera receive an external multimedia datum while the apparatus 1200 is in an operation mode, such as a photographing mode or a video mode. Each of the front camera and the rear camera has a fixed optical lens system or has focus and optical zoom capability.

The audio component 1210 is configured to output and/or input audio signals. In some embodiments, the audio component 1210 includes a microphone configured to receive an external audio signal when the apparatus 1200 is in an operation mode, such as a call mode, a recording mode, and a voice recognition mode. In some embodiments, the received audio signal is further stored in the memory 1204 or transmitted via the communication component 1216. In some embodiments, the audio component 1210 further includes a speaker configured to output audio signals.

The I/O interface 1212 is configured to provide an interface between the processing component 1202 and peripheral interface modules, such as a keyboard, a click wheel, buttons, and the like. In some embodiments, the buttons include, but are not limited to, a home button, a volume button, a starting button, and a locking button.

The sensor component 1214 includes one or more sensors to provide status assessments of various aspects of the apparatus 1200. For example, in some embodiments, the sensor component 1214 detects an open/closed status of the apparatus 1200, relative positioning of components, e.g., the display and the keypad, of the apparatus 1200, a change in position of the apparatus 1200 or a component of the apparatus 1200, a presence or absence of user contact with the apparatus 1200, an orientation or an acceleration/deceleration of the apparatus 1200, and/or a change in temperature of the apparatus 1200. In some embodiments, the sensor component 1214 includes a proximity sensor configured to detect the presence of nearby objects without any physical contact. In some embodiments, the sensor component 1214 includes a light sensor, such as a CMOS or CCD image sensor, for use in imaging applications. In some embodiments, the sensor component 1214 also includes an accelerometer sensor, a gyroscope sensor, a magnetic sensor, a pressure sensor, or a temperature sensor.

The communication component 1216 is configured to facilitate wired or wireless communication between the apparatus 1200 and other devices. In some embodiments, the apparatus 1200 accesses a wireless network based on a communication standard, such as WiFi, 2G, 3G, 4G, or a combination thereof. In one embodiment, the communication component 1216 receives a broadcast signal or broadcast associated information from an external broadcast management system via a broadcast channel. In one embodiment, the communication component 1216 includes a near field communication (NFC) module configured to facilitate short-range communications. For example, the NFC module can be implemented based on a radio frequency identification (RFID) technology, an infrared data association (IrDA) technology, an ultra-wideband (UWB) technology, a Bluetooth (BT) technology, and other technologies.

In some embodiments, the apparatus 1200 is implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

The present disclosure also provides a non-transitory computer-readable storage medium including instructions, such as included in the memory 1204, executable by the processor 1220 in the apparatus 1200, for performing the disclosed methods. For example, the non-transitory computer-readable storage medium can be a ROM, a RAM, a CD-ROM, a magnetic tape, a floppy disc, an optical data storage device, and the like.

The present disclosure also provides a non-transitory computer readable storage medium including instructions that, when executed by the processor 1220 of the apparatus 1200, enables the apparatus 1200 to perform a method for establishing a connection to a data service. The method includes:

after the mobile terminal is registered to an LTE network, searching for a preset first APN in the mobile terminal;

initiating a first request on the LTE network for connecting to the data service with the first APN that is found in the search;

when a message fed back by the LTE network is received indicating that initiating the first request for connecting to the data service fails, acquiring a second APN assigned to the mobile terminal by the LTE network to which the mobile terminal is registered; and

initiating a second request on the LTE network for connecting to a data service with the second APN, to establish the connection to the data service.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for establishing a connection to a data service, which is implemented by a mobile terminal, the method comprising:
when initiating a first request on a Long Term Evolution (LTE) network for connecting to the data service with a first Access Point Name (APN) preset in the mobile terminal fails, acquiring a second APN, the second APN being assigned to the mobile terminal by the LTE network when the mobile terminal is attached to the LTE network; and
initiating a second request on the LTE network for connecting to the data service with the second APN, to establish the connection to the data service.

2. The method of claim 1, wherein initiating the first request on the LTE network for connecting to the data service with the first APN preset in the mobile terminal includes:
after the mobile terminal is attached to the LTE network, searching for the first APN preset in the mobile terminal; and
initiating the first request on the LTE network for connecting to the data service with the first APN that is found in the search.

3. The method of claim 1, wherein acquiring the second APN includes:
sending a command for searching for the second APN to a Baseband processor (BP) system of the mobile terminal; and
acquiring the second APN returned by the BP system.

4. The method of claim 3, wherein sending the command for searching for the second APN to the BP system of the mobile terminal includes:
sending the command for searching for the second APN to the BP system of the mobile terminal through a Radio Interface Layer of the mobile terminal.

5. The method of claim 2, wherein searching for the first APN preset in the mobile terminal includes:
according to a type of the LTE network to which the mobile terminal is attached, searching for the first APN that corresponds to the type of the LTE network from preset APNs stored in the mobile terminal.

6. The method of claim 1, wherein initiating the second request on the LTE network for connecting to the data service with the second APN includes:
acquiring an IP address assigned by the LTE network to the mobile terminal during a process of attaching to the LTE network; and
initiating the second request on the LTE network for connecting to the data service with the IP address and the second APN.

7. The method of claim 2, wherein initiating the second request on the LTE network for connecting to the data service with the second APN includes:
acquiring an IP address assigned by the LTE network to the mobile terminal during a process of attaching to the LTE network; and
initiating the second request on the LTE network for connecting to the data service with the IP address and the second APN.

8. The method of claim 3, wherein initiating the second request on the LTE network for connecting to the data service with the second APN includes:
acquiring an IP address assigned by the LTE network to the mobile terminal during a process of attaching to the LTE network; and
initiating the second request on the LTE network for connecting to the data service with the IP address and the second APN.

9. An apparatus for establishing a connection to a data service, comprising:
a processor; and
a memory for storing instructions executable by the processor;
wherein the processor is configured to execute the instructions to perform:
when initiating a first request on a Long Term Evolution (LTE) network for connecting to a data service with a first Access Point Name (APN) preset in the mobile terminal fails, acquiring a second APN, the second APN being assigned to the mobile terminal by the LTE network when the mobile terminal is attached to the LTE network; and
initiating a second request on the LTE network for connecting to the data service with the second APN, to establish the connection to the data service.

10. The apparatus of claim 9, wherein initiating the first request on the LTE network for connecting to the data service with the first APN preset in the mobile terminal includes:
after the mobile terminal is attached to the LTE network, searching for the first APN preset in the mobile terminal; and
initiating the first request on the LTE network for connecting to the data service with the first APN that is found in the search.

11. The apparatus of claim 9, wherein acquiring the second APN includes:
sending a command for searching for the second APN to a Baseband processor (BP) system of the mobile terminal; and
acquiring the second APN returned by the BP system.

12. The apparatus of claim 11, wherein sending the command for searching for the second APN to the BP system of the mobile terminal includes:
sending the command for searching for the second APN to the BP system of the mobile terminal through a Radio Interface Layer of the mobile terminal.

13. The apparatus of claim 10, wherein searching for the first APN preset in the mobile terminal includes:
according to a type of the LTE network to which the mobile terminal is attached, searching for the first APN that corresponds to the type of the network from preset APNs stored in the mobile terminal.

14. The apparatus of claim 9, wherein initiating the second request on the LTE network for connecting to the data service with the second APN includes:
acquiring an IP address assigned by the LTE network to the mobile terminal during a process of attaching to the LTE network; and
initiating the second request on the LTE network for connecting to the data service with the IP address and the second APN.

15. A non-transitory computer-readable storage medium storing instructions that, when executed by a processor of a mobile terminal for establishing a connection to a data service, cause the processor to perform a method comprising:
when initiating a first request on a Long Term Evolution (LTE) network for connecting to the data service with a first Access Point Name (APN) preset in the mobile terminal fails, acquiring a second APN, the second APN being assigned to the mobile terminal by the LTE network when the mobile terminal is attached to the LTE network; and
initiating a second request on the LTE network for connecting to the data service with the second APN, to establish the connection to the data service.

16. The non-transitory computer-readable storage medium of claim 15, wherein initiating the first request on the LTE network for connecting to the data service with the first APN preset in the mobile terminal includes:
after the mobile terminal is attached to the LTE network, searching for the first APN preset in the mobile terminal; and
initiating the first request on the LTE network for connecting to the data service with the first APN that is found in the search.

17. The non-transitory computer-readable storage medium of claim 15, wherein acquiring the second APN includes:
sending a command for searching for the second APN to a Baseband processor (BP) system of the mobile terminal; and
acquiring the second APN returned by the BP system.

18. The non-transitory computer-readable storage medium of claim 17, wherein sending the command for searching for the second APN to the BP system of the mobile terminal includes:
sending the command for searching for the second APN to the BP system of the mobile terminal through a Radio Interface Layer of the mobile terminal.

19. The non-transitory computer-readable storage medium of claim 16, wherein searching for the first APN preset in the mobile terminal includes:
according to a type of the LTE network to which the mobile terminal is attached, searching for the first APN that corresponds to the type of the network from preset APNs stored in the mobile terminal.

20. The non-transitory computer-readable storage medium of claim 15, wherein initiating the second request on the LTE network for connecting to the data service with the second APN includes:
acquiring an IP address assigned by the LTE network to the mobile terminal during a process of attaching to the LTE network; and
initiating the second request on the LTE network for connecting to the data service with the IP address and the second APN.
